(19) United States
(12) Patent Application Publication
(10) Pub. No.: US 2024/0283504 A1
(43) Pub. Date: Aug. 22, 2024

(54) SYSTEMS AND METHODS FOR IMPROVING ANTENNA SWITCHING IN MOBILE DEVICES

(71) Applicant: Meta Platforms Technologies, LLC, Menlo Park, CA (US)

(72) Inventors: Fengyu Ge, Monroe, WA (US); Jibu Joseph, Santa Clara, CA (US); Pritesh Vora, San Diego, CA (US); Nil Apaydin, Kirkland, WA (US); Liang Han, Sunnyvale, CA (US)

(21) Appl. No.: 18/172,361

(22) Filed: Feb. 22, 2023

(51) Int. Cl. H04B 7/06

(52) U.S. Cl. CPC H04B 7/0602

(57) ABSTRACT

A disclosed computer-implemented method may include receiving, from a sensor included in an artificial reality system, data representative of an environment local to the artificial reality system. The disclosed method may also include determining, based on the received data representative of the environment, a probability that an environmental condition will impact a use of a plurality of antennas included in the artificial reality system by the artificial reality system. The disclosed method may also include adjusting, in response to the determined probability that the environmental condition will interfere with the use of the plurality of antennas, the use of the plurality of antennas by the artificial reality system. Various other methods, systems, and computer-readable media are also disclosed.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for improving antenna switching in mobile devices.

FIGS. 2-3 are block diagrams of example implementations of a system for improving antenna switching in mobile devices.

FIG. 4 is a flow diagram of an example computer-implemented method for improving antenna switching in mobile devices.

FIG. 5 is an illustration of example augmented-reality glasses that may be used in connection with embodiments of this disclosure.

FIG. 6 is an illustration of an example virtual-reality headset that may be used in connection with embodiments of this disclosure.

FIG. 7 is an illustration of an example smartwatch that may be used in connection with embodiments of this disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

Artificial reality (AR) systems such as virtual reality systems and augmented reality systems may include a plurality of antennas. Antenna switching in AR systems may be very challenging and complex when compared to other mobile devices such as smartphones or other existing consumer electronics. AR devices may be much smaller in surface area and/or volume and may have more added features, thereby reducing space for antennas. Simultaneously, AR devices may require much higher antenna performance than other mobile devices to maintain an acceptable user experience.

Conventional antenna switching systems and methods for wireless systems generally use algorithms to select a transmit or receive path to the best performing antennas. For example, a smartphone may have four antennas to support a particular band such as Long-Term Evolution (LTE) band 41. A conventional antenna switching system may select any of the four antennas as transmit or receive antennas, basing such switching selection on a measured power from each transmit and receive antenna to decide which antennas have the best performance at a particular time. Antenna environment changes such as device orientation and user hand grip, may change transmit and receive power measured by the conventional switching system. A conventional antenna switching algorithm may monitor the antenna performance changes (i.e., a measured power from each transmit and receive antenna) and may switch antennas accordingly.

However, the more complex use cases of AR systems may bring many challenges to antenna switching. One of these challenges may be an impact of specific absorption rate (SAR) due to a reduced device size and/or an increased number of antennas for devices used within AR systems. For example, when held in a user's hands, smaller device sizes may result in one or more antennas being covered by the user's hands, increasing an overall SAR. To meet SAR requirements, transmit power from antennas covered by a user's hands may have to drop significantly. Furthermore, when a user's hands or body cannot be differentiated from other objects, conventional antenna switching systems may switch a transmit path to antennas that are in close proximity to a user's hand or body, thereby increasing SAR and reducing radio performance.

Another challenge in AR systems may be demanding wireless performance requirements from AR applications. For example, augmented reality applications may require a much higher data rate than many smartphone applications. Unsatisfactory antenna switching may result in poor user experience and increased power consumption. Hence, the instant application identifies and addresses a need for systems and methods for improved antenna switching in mobile devices, and particularly in AR systems and/or devices.

The present disclosure is generally directed to systems and methods for improving antenna switching in mobile devices. As will be explained in greater detail below, embodiments of the present disclosure may receive, via a sensor included in an artificial reality system (e.g., a camera, a depth sensor, a proximity sensor, etc.), data representative of an environment local to the artificial reality system. Embodiments may also determine, based on the received data representative of the environment, a probability that an environmental condition will impact a use of a plurality of antennas included in the artificial reality system. Embodiments may further adjust, in response to the determined probability that environmental condition the environment will interfere with the use of the plurality of antennas (e.g., when the probability exceeds a predetermined probability threshold), the use of the plurality of antennas, such as by switching antennas, adjusting impedance matching of antennas, and so forth.

In some embodiments, the systems and methods described herein may use inputs from one or more sensors to improve antenna switching within mobile systems, and particularly within AR systems. For example, some AR systems may include a variety of sensors (e.g., cameras, touch sensors, proximity sensors, motion sensors, etc.). Embodiments of the systems and methods described herein may incorporate data from sensors to improve antenna switching, such as by identifying and selecting, if available, antennas free from obstruction for transmission and/or reception of electromagnetic signals.

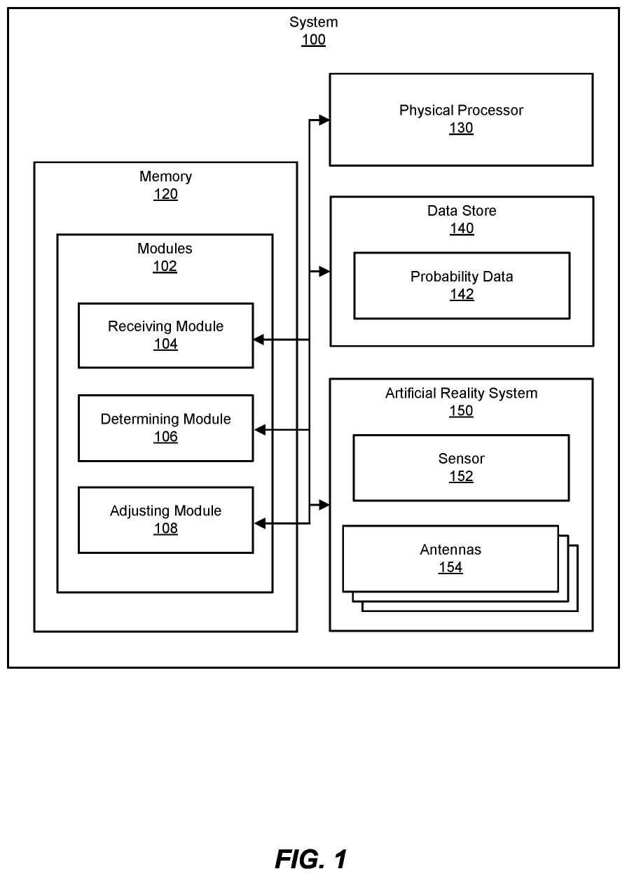

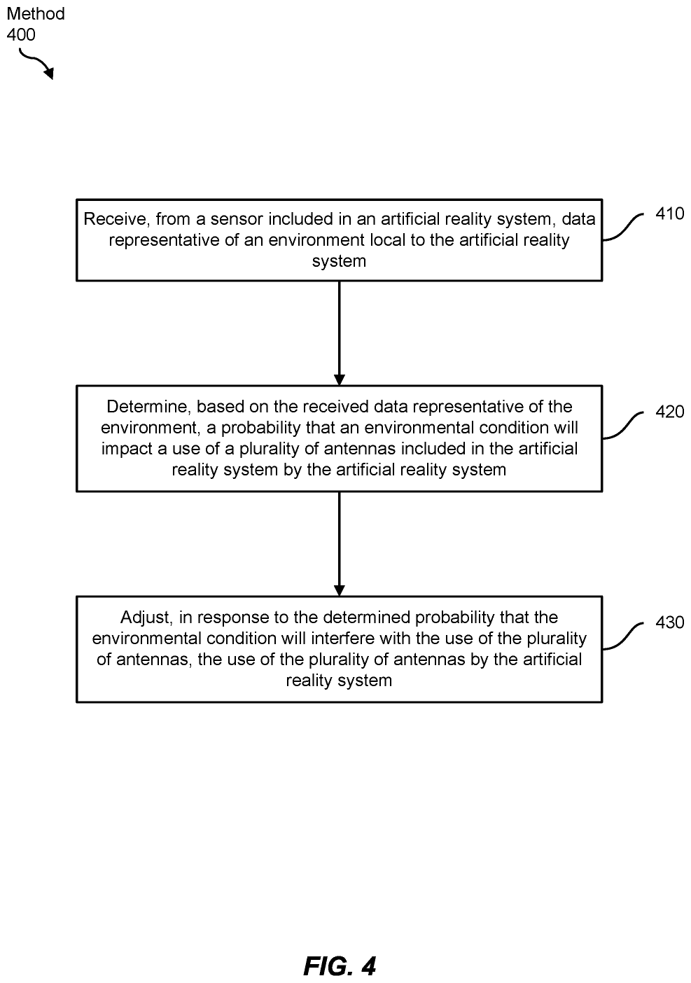

The following will provide, with reference to FIGS. 1-2 and 4-7, detailed descriptions of systems for improving antenna switching in mobile devices. Detailed descriptions of corresponding computer-implemented methods will also be provided in connection with FIG. 4.

FIG. 1 is a block diagram of an example system 100 for improving antenna switching in mobile devices. As illustrated in this figure, example system 100 may include one or more modules 102 for performing one or more tasks. As will be explained in greater detail below, modules 102 may include a receiving module 104 that receives, from a sensor included in an artificial reality system, data representative of an environment local to the artificial reality system. Example system 100 may also include a determining module 106 that determines, based on the received data representative of the environment, a probability that an environmental condition will impact a use, by the artificial reality system, of the plurality of antennas. Example system 100 may further include an adjusting module 108 that adjusts, in response to the determined probability that the environmental condition will interfere with the use of the plurality of antennas, the use, by the artificial reality system, of the plurality of antennas by the artificial reality system.

As further illustrated in FIG. 1, example system 100 may also include one or more memory devices, such as memory 120. Memory 120 generally represents any type or form of volatile or non-volatile storage device or medium capable of storing data and/or computer-readable instructions. In one example, memory 120 may store, load, and/or maintain one or more of modules 102. Examples of memory 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As further illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 120. Additionally or alternatively, physical processor 130 may execute one or more of modules 102 to facilitate improving antenna switching in mobile devices. Examples of physical processor 130 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As also shown in FIG. 1, example system 100 may also include one or more data stores, such as data store 140, that may receive, store, and/or maintain data. Data Store 140 may represent portions of a single data store or computing device or a plurality of data stores or computing devices. In some embodiments, data store 140 may be a logical container for data and may be implemented in various forms (e.g., a database, a file, a file system, a data structure, etc.). Examples of data store 140 may include, without limitation, files, file systems, data stores, databases, and/or database management systems such as an operational data store (ODS), a relational database, a NoSQL database, a NewSQL database, and/or any other suitable organized collection of data.

In at least one example, data store 140 may include probability data 142. As will be explained in greater detail below, in some examples, probability data 142 may include any information that one or more modules 102 may use to identify, calculate, detect, and/or otherwise determine, based on received data representative of an environment, a probability that an environmental condition will impact a use of a plurality of antennas included in an artificial reality system. In some examples, probability data 142 may include a machine learning model such as a pre-trained and/or trainable artificial neural network (ANN) configured and/or trained to determine a probability of an outcome and/or result based on data representative of an environment local to an artificial reality system (e.g., artificial reality system 150).

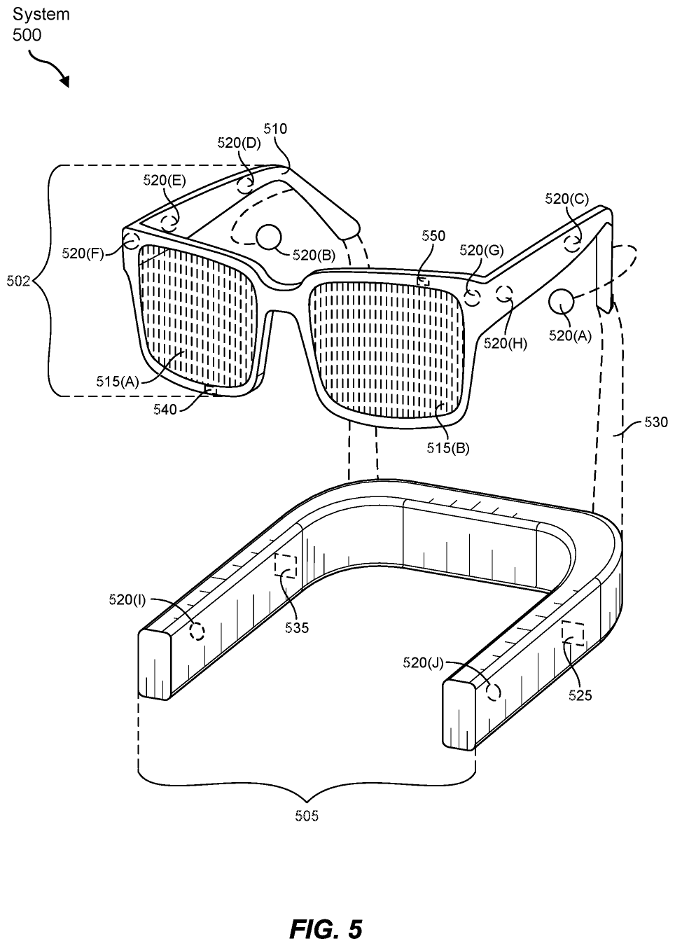

As further shown in FIG. 1, example system 100 may also include an artificial reality system 150. Examples and illustrations of artificial reality systems that may be included in and/or may be implemented in conjunction with example system 100 will be provided below in connection with FIGS. 5-7. As shown in FIG. 1, artificial reality system 150 may include at least one sensor 152. Sensor 152 may include any device, component, or implement that may detect and respond to some type or form of input from a physical environment. Examples of sensor 152 may include, without limitation, a camera, an array of cameras, a computer vision system, a simultaneous localization and mapping (SLAM) subsystem, a temperature sensor, a touch sensor, an orientation sensor, a proximity sensor, a motion sensor, and so forth.

As also shown in FIG. 1, artificial reality system 150 may also include a plurality of antennas 154. In some examples, an antenna may include any structure, device, and/or element that converts radio frequency (RF) fields into a signal (e.g., an electrical signal) or vice versa. An antenna may include any electrical conductor that has a purpose of transmitting and/or receiving electromagnetic waves and/or electromagnetic radiation. An antenna may be electrically and/or communicatively coupled to a processing device that may be configured to translate RF fields into discernable signals and/or to convert signals into transmittable RF fields.

Artificial reality system 150 and/or antennas 154 may include antennas configured to transmit and/or receive a variety of wavelengths of electromagnetic radiation and/or in accordance with one or more wireless telecommunication standards. Furthermore, any antenna included in antennas 154 may be configured to and/or capable of transmitting and/or receiving electromagnetic radiation and/or in accordance with one or more wireless telecommunications standards. Examples of wireless telecommunications standards that one or more of antennas 154 may be configured to facilitate may include, without limitation, personal-area networking (PAN) wireless standards such as Bluetooth, Wi-Fi Direct, and/or near-field communications (NFC), local-area networking (LAN) wireless standards such as a 802.11 or Wi-Fi standard, and/or wide-area networking (WAN) wireless standards such as a Global System for Mobile (GSM) wireless standard, a General Packet Radio Service (GPRS) wireless standard, a Code Division Multiple Access (CDMA) wireless standard, a Long-Term Evolution (LTE) wireless standard, or a Fifth Generation (5G) wireless standard.

Additionally or alternatively, antennas 154 may be configured to receive electromagnetic signals from any suitable transmission source including, without limitation, one or more satellite-based navigation systems (e.g., the Global Positioning System (GPS), the Global Navigation Satellite System (GLONASS), the Bei Dou Navigation Satellite System, the Galileo system, and so forth).

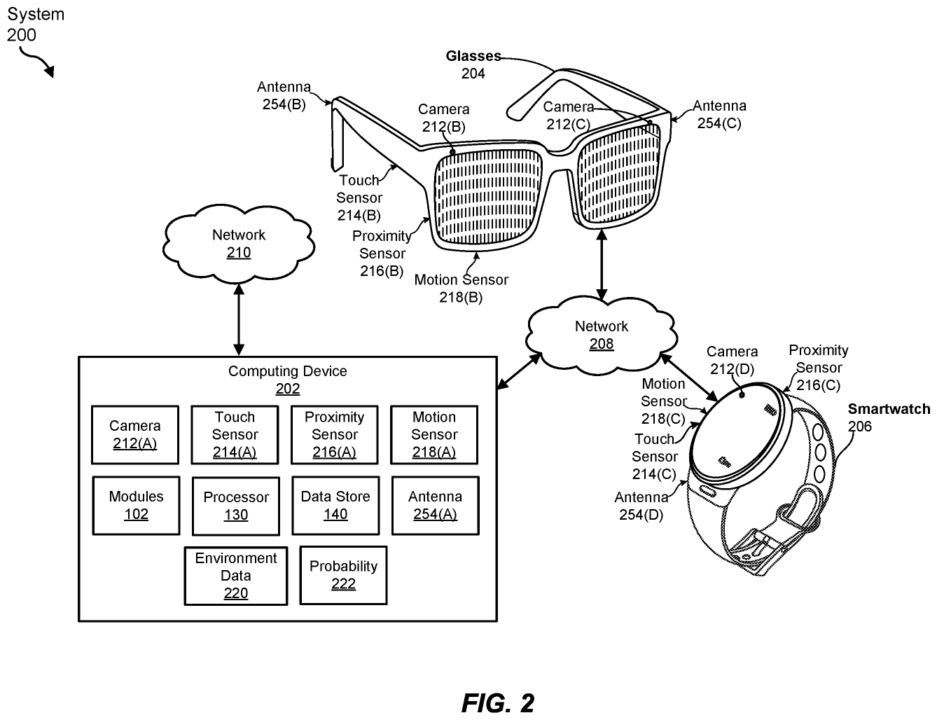

By way of illustration, a first antenna included in antennas 154 may be configured to transmit and/or receive LTE signals and 5G signals, while a second antenna included in antennas 154 may be configured to transmit and/or receive LTE signals, GSM signals, and GPS signals. Additional examples of multi-antenna systems will be provided in connection with FIGS. 2-4 below.

Example system 100 in FIG. 1 may be implemented in a variety of ways. For example, all or a portion of example system 100 may represent portions of an example system 200 (“system 200”) in FIG. 2. As shown in FIG. 2, system 200 may include a computing device 202 in communication with a wearable device 204 (also “glasses 204” herein) and a wearable device 206 (also “smartwatch 206” herein). In at least one example, computing device 202 may be programmed with one or more of modules 102. Additionally or alternatively, although not shown in FIG. 2, wearable device 204 and/or wearable device 206 may be programmed with one or more of modules 102.

In at least one embodiment, one or more modules 102 from FIG. 1 may, when executed by computing device 202, wearable device 204, and/or wearable device 206, enable user device 202, wearable device 204, and/or wearable device 206 to perform one or more operations to improve antenna switching in mobile devices. For example, as will be described in greater detail below, receiving module 104 may cause computing device 202, wearable device 204, and/or wearable device 206 to receive, via a sensor (e.g., at least one of cameras 212, touch sensors 214, proximity sensors 216, motion sensors 218, etc.) included in an artificial reality system (e.g. artificial reality system 150, example system 200, etc.), data representative of an environment local to the artificial reality system (e.g., environment data 220).

Additionally, in some embodiments, determining module 106 may determine, based on the received data representative of the environment, a probability (e.g., probability 222) that an environmental condition will impact a use of a plurality of antennas included in the artificial reality system (e.g., antennas 254) by the artificial reality system. In further examples, in response to the determined probability that the environment will interfere with the use of the plurality of antennas, adjusting module 108 may adjust the use of the plurality of antennas by the artificial reality system.

As a simplified illustration, camera 212(C) included in wearable device 204 may record data (e.g., may record data representative of light received by camera 212(C)) and may transmit the data to computing device 202. One or more of modules 102 (e.g., receiving module 104) may receive the data and may process the data to determine (e.g., via determining module 106) a probability (e.g., probability 222) that an object is in close proximity to antenna 254(B). As an object in close proximity to antenna 254(B) may interfere with operation of antenna 254(B), one or more of modules 102 (e.g., adjusting module 108) may adjust an operation of one or more antennas 254, such as by reducing a power output of antenna 254(B) and/or increasing a power output of antenna 254(A), antenna 254(C) and/or antenna 254(D). This adjustment may enable example system 200 to avoid any signal interruption that may be caused by an object being in proximity to antenna 254(B) and may enable example system 200 to provide a consistent, high-quality interactive experience to one or more users of example system 200.

Computing device 202 generally represents any type or form of computing device capable of reading and/or executing computer-executable instructions. In at least one embodiment, computing device 202 may accept one or more directions from wearable device 204 and/or wearable device 206. Examples of computing device 202 include, without limitation, servers, desktops, laptops, tablets, cellular phones, (e.g., smartphones), personal digital assistants (PDAs), multimedia players, embedded systems, wearable devices (e.g., smart watches, smart glasses, etc.), gaming consoles, combinations of one or more of the same, or any other suitable mobile computing device.

Wearable device 204 and wearable device 206 may also generally represent any type or form of computing device capable of reading and/or executing computer-readable instructions while being worn or carried by a user. Examples of wearable device 204 and/or wearable device 206 may be provided below in reference to FIGS. 5-7. Although illustrated in FIG. 2 as a pair of smart glasses and a smart watch respectively, these are provided as illustrations or examples only and not by way of limitation. Indeed, wearable device 204 and/or wearable device 206 may take any suitable form that may otherwise include or implement one or more elements or functions of example system 100.

Network 208 generally represents any medium or architecture capable of facilitating communication and/or data transfer between computing device 202, wearable device 204, and wearable device 206. Examples of network 208 include, without limitation, an intranet, a WAN, a LAN, a PAN, the Internet, Power Line Communications (PLC), a cellular network (e.g., a GSM network, a CDMA network, an LTE network, a 5G network, etc.), universal serial bus (USB) connections, Bluetooth connections, and the like. Network 208 may facilitate communication or data transfer using wireless or wired connections. In one embodiment, network 208 may facilitate communication between computing device 202, wearable device 204, and/or wearable device 206.

Likewise, network 210 generally represents any medium or architecture capable of facilitating communication and/or data transfer between computing device 202, wearable device 204, wearable device 206, and a computing device or service external to example system 200. Examples of network 210 may include, without limitation, an intranet, a WAN, a LAN, a PAN, the Internet, PLC, a cellular network (e.g., a GSM network, a CDMA network, an LTE network, a 5G network, etc.), USB connections, Bluetooth connections, and the like. Although illustrated as separate networks in FIG. 2, in some embodiments, network 208 and network 210 may include or represent portions or components of the same network.

In some embodiments, computing device 202, wearable device 204 and/or wearable device 206 may include one or more sensors, such as one or more cameras 212, one or more touch sensors 214, one or more proximity sensors 216, one or more motion sensors 218, and so forth. Note that these sensors are provided by way of example only, and that any of computing device 202, wearable device 204 and/or wearable device 206 may additionally or alternatively include any other sensor that may be capable of generating an output signal in response to perceiving, detecting, or measuring a physical property of an environment local to one or more components of example system 200.

As further shown in FIG. 2, computing device 202, wearable device 204, and/or wearable device 206 may include or be in communication with one or more antennas 254. Antennas 254 may collectively implement antennas 154 as described above in reference to FIG. 1. As illustrated in FIG. 2, each of computing device 202, wearable device 204, and/or wearable device 206 may include one or more of antennas 254, with computing device 202 including an antenna 254(A), wearable device 204 including an antenna 254(B) and an antenna 254(C), and wearable device 206 including an antenna 254(D). The configuration of antennas 254 in FIG. 2 is shown for illustrative purposes only. Antennas 254 may include any number of antennas that may be distributed throughout example system 200 in any arrangement or configuration.

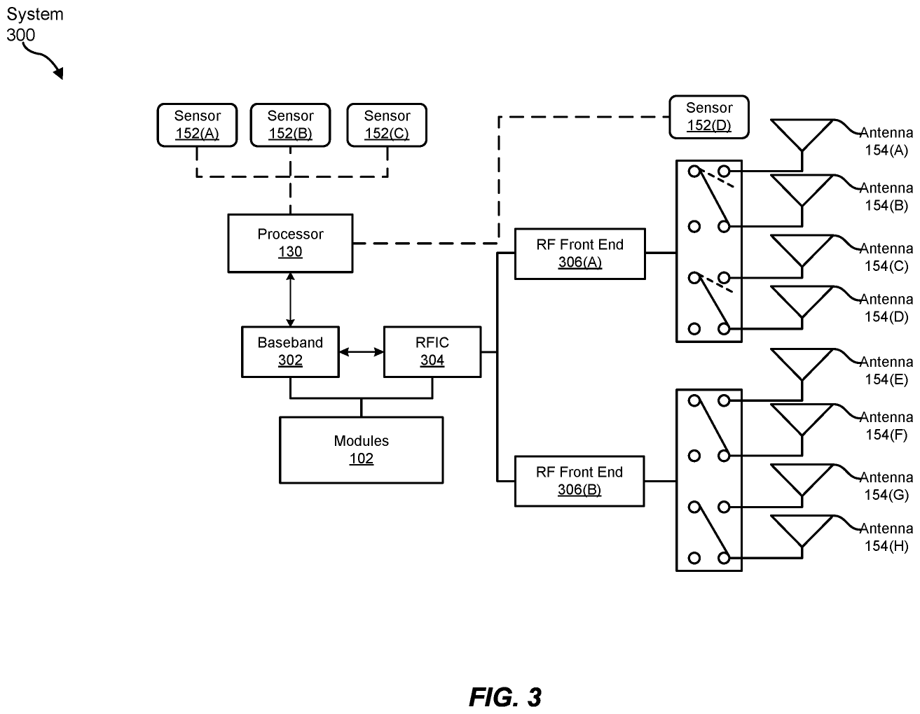

FIG. 3 includes a block diagram of an additional or alternative implementation of an example system for improving antenna switching in mobile devices. Although not all shown in FIG. 3, the components of example system 300 in FIG. 3 may include or implement the components or features of example system 100 included in FIG. 1.

As shown, FIG. 3 includes modules 102, physical processor 130, sensors 152, and antennas 154. Although only four sensors 152 and eight antennas 154 are shown in FIG. 3, example system 300 may include any number of sensors 152 and/or antennas 154. Example system 300 further includes a baseband signal 302 (“Baseband 302” in FIG. 3), an RF integrated circuit 304 (“RFIC 304” in FIG. 3) and a plurality of RF front ends 306 (e.g., RF front end 306(A) and RF front end 306(B)).

Baseband signal 302 may include or represent any suitable baseband signal that may be decoded or encoded by a suitable RFIC. RFIC 304 may include or represent an integrated circuit that may encode baseband signal 302 into a signal for transmission by one or more antennas 154 and/or may decode baseband signal 302 from a signal received by one or more antennas 154. Front ends 306 may include or represent any circuitry that may convert an analog electromagnetic signal received by one or more antennas 154 into a digital signal that may be processed by RFIC 304 and/or any circuitry that may convert a digital signal from RFIC 304 for transmission as an analog signal by one or more antennas 154. In the example shown in FIG. 3, RF front end 306(A) may be included as part of a first device included in an AR system (e.g., a computing device like computing device 202 or a wearable device like wearable device 204 and/or wearable device 206) and RF front end 306(B) may be included as part of a second device included in an AR system (e.g., a computing device like computing device 202 or a wearable device like wearable device 204 and/or wearable device 206).

As shown in FIG. 3, physical processor 130 may receive and/or process environmental data (e.g., environment data 220) from one or more sensors (e.g., one or more of sensor 152(A), sensor 152(B), sensor 152(C), and sensor 152(D)) in accordance with one or more modules 102 (e.g., receiving module 104, determining module 106, adjusting module 108, etc.). Furthermore, one or more of modules 102 (e.g., determining module 106) may, when executed by physical processor 130, cause physical processor 130 to adjust a use of one or more antennas 154 (e.g., via RF front ends 306) based on a determined probability (e.g., probability 222) that an environmental condition will interfere with a use (e.g., transmission or reception of a signal by) of one or more antennas 154.

Many other devices or subsystems may be connected to example system 100 in FIG. 1, example system 200 in FIG. 2, and/or example system 300 in FIG. 3. Conversely, all of the components and devices illustrated in FIGS. 1-3 need not be present to practice the embodiments described and/or illustrated herein. The devices and subsystems referenced above may also be interconnected in different ways from those shown in FIG. 2 and/or FIG. 3. Example systems 100, 200, and 300 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 4 is a flow diagram of an example computer-implemented method 400 for improving antenna switching in mobile devices. The steps shown in FIG. 4 may be performed by any suitable computer-executable code and/or computing system, including example system 100 in FIG. 1, example system 200 in FIG. 2, example system 300 in FIG. 3, and/or variations or combinations of one or more of the same. In one example, each of the steps shown in FIG. 4 may represent an algorithm whose structure includes and/or is represented by multiple sub-steps, examples of which will be provided in greater detail below.

As illustrated in FIG. 4, at step 410, one or more of the systems described herein may receive, via a sensor included in an artificial reality system, data representative of an environment local to the artificial reality system. For example, receiving module 104 may, as part of computing device 202, wearable device 204, and/or wearable device 206 in FIG. 2, cause computing device 202, wearable device 204, and/or wearable device 206 to receive, via at least one of cameras 212, touch sensors 214, proximity sensors 216, motion sensors 218, and/or any other sensor included in example system 200, environment data 220.

Receiving module 104 may receive environment data 220 in a variety of ways or contexts. As described above, a sensor (e.g., sensor 152) may include any device, component, or implement that may detect and respond to some type or form of input from a physical environment (e.g., a physical environment local to AR system 150). By way of example, when sensor 152 includes a camera, sensor 152 may detect a change in light received by sensor 152. Likewise, when sensor 152 includes a proximity sensor, sensor 152 may detect a proximity of an object to sensor 152. When sensor 152 includes a motion sensor, sensor 152 may detect a motion of sensor 152 and/or a motion of an object within a sensory perception of sensor 152. The foregoing are provided by way of example and not by way of limitation, as sensor 152 may include any suitable type or quantity of sensor.

Hence, receiving module 104 may receive a signal from sensor 152, and the signal may include or represent a condition of an environment local to sensor 152 and/or local to AR system 150. Therefore, receiving module 104 may receive a signal that may include or represent environment data 220.

Returning to FIG. 4, at step 420, one or more of the systems described herein may determine, based on received data representative of the environment, a probability that an environmental condition will impact a use of a plurality of antennas included in the artificial reality system by the artificial reality system. For example, determining module 106 may determine, based on environment data 220, probability 222 that an environmental condition will impact a use (e.g., reception and/or transmission of a signal) of antennas 154.

Determining module 106 may determine probability 222 in a variety of contexts. For example, as described above, in some embodiments, environment data 220 may include image data captured by one or more cameras, such as camera 212(C) included in FIG. 2. Determining module 106 may analyze environment data 220 in accordance with an image analysis or computer vision algorithm and may determine, based on such analysis, that an object may, within a predetermined time period, be in a proximity to antenna 254(C). Based on this analysis, determining module 106 may determine, as probability 222, a probability that a use (e.g., a transmission or reception of a signal) by the one or more antennas 254 may be impacted by proximity of the object to antenna 254(C).

In another example, environmental data 220 may include proximity data gathered from a proximity sensor, such as proximity sensor 216(C) included in FIG. 2. Determining module 106 may determine, based on the proximity data included in environment data 220, a probability 222 that an object will, within a predetermined time period, be in a proximity to antenna 254(D), and that the proximity of the object to antenna 254(D) may impact a use (e.g., transmission or reception of a signal) of antenna 254(D). Hence, as will be described in greater detail below, adjusting module 108 may adjust a use of antennas 254 in response to probability 222 (e.g., in response to probability 222 being greater than a predetermined probability threshold).

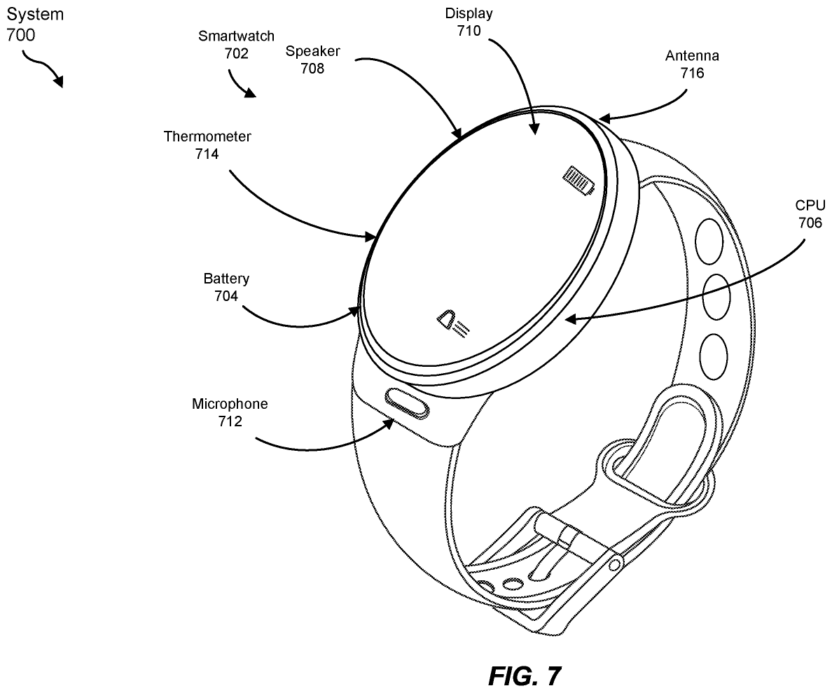

As another example, performance of one or more antennas included in antennas 254 may be impacted by variations in temperature among antennas 254. For example, as shown and described in greater detail below in reference to FIG. 7, sensor 152 may include a thermometer, such as thermometer 714. Thermometer 714 may detect that smartwatch 702 is at a relatively low temperature, such as 0° C., and may provide the temperature to determining module 106 (e.g., via receiving module 104) as environment data 220. Such a temperature may impact a performance of antenna 716 included in smartwatch 702. Hence, based on environment data 220 indicating a temperature that may impact a performance of antenna 716, determining module 106 may determine probability 222 that may indicate a probability that performance of antenna 716 may be reduced. As will be described in greater detail below, adjusting module 108 may adjust a use of antenna 716 based on probability 222 indicating a probability that performance of antenna 716 may be reduced.

In some examples, determining module 106 may determine probability 222 by analyzing environment data 220 in accordance with a machine learning model that has been pre-trained to determine probabilities of antenna interference based on inputs from one or more sensors. Such a model may be included as part of probability data 142 and may include, without limitation, a supervised model, an unsupervised model, a regression model, a classification model, a decision tree, a random forest, a Bayesian classifier, an ANN including an input layer, an output layer, and one or more hidden layers, and so forth. Hence, in some examples, determining module 106 may determine probability 222 by providing environment data 220 as input to a machine learning model that has been pre-trained to determine probabilities of antenna interference based on inputs from one or more sensors.

Returning to FIG. 4, at step 430, one or more of the systems described herein may adjust, in response to the determined probability that the environmental condition will impact the use of the plurality of antennas, the use of the plurality of antennas by the artificial reality system. For example, adjusting module 108 may, as part of computing device 202, wearable device 204, and/or wearable device 206 in FIG. 2, adjust, in response to probability 222 determined by determining module 106, a use of antennas 254.

Adjusting module 108 may adjust a use of antennas 254 in a variety of contexts. For example, as described above, antennas 254 may include at least a first antenna, such as antenna 254(B), and a second antenna, such as antenna 254(C). Probability 222 may indicate a probability that a use of antenna 254(B) will be interfered with within a predetermined time period, such as by an object (e.g., a body part of a user) coming within a predetermined proximity to antenna 254(B). In response, adjusting module 108 may adjust a use of antennas 254 by adjusting a transmit path of example system 200 such that the transmit path excludes antenna 254(B) and includes antenna 254(C). This may mitigate an impact of the proximity of the object to antenna 254(B).

Adjusting module 108 may adjust the use of antennas 254 in any suitable way that may mitigate an impact of interference with one or more of antennas 254. For example, adjusting module 108 may adjust a use of antennas 254 by decreasing an input sensitivity of a first antenna and increasing an input sensitivity of a second antenna. Additionally or alternatively, adjusting module 108 may adjust a use of antennas 254 by decreasing a power output of the first antenna and increasing the power output of the second antenna. In some embodiments, adjusting module 108 may adjust the use of antennas 254 by transitioning a first antenna from an active state to an inactive state, and by transitioning a second antenna from an inactive state to an active state.

As discussed throughout the instant disclosure, the disclosed systems and methods may provide one or more advantages over traditional options for antenna switching in mobile devices, and particularly in AR systems. AR devices include a variety of sensors that may provide input regarding an environment within which the AR devices are operating. The systems and methods described herein may incorporate this input to improve antenna switching over conventional antenna switching methods.

For example, integrated proximity sensors can detect objects in proximity to an antenna. Inputs from these proximity sensors may enable a multi-antenna system to select antennas free from obstruction if any are available. Additionally, camera systems and their associated algorithms may be used to identify objects in proximity to antennas, further improving antenna switching. Using data processing as described herein, a use of an antenna system (e.g., a transmit path) may be adjusted or modified based on, for example, how a device is held by a user, whether one or more antennas are currently obstructed, and so forth. Hence, the systems and methods described herein may improve and/or optimize antenna switching to avoid antennas that may have temporarily reduced performance based on a current orientation, temperature, state of obstruction, and so forth.

Embodiments of the present disclosure may include or be implemented in-conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

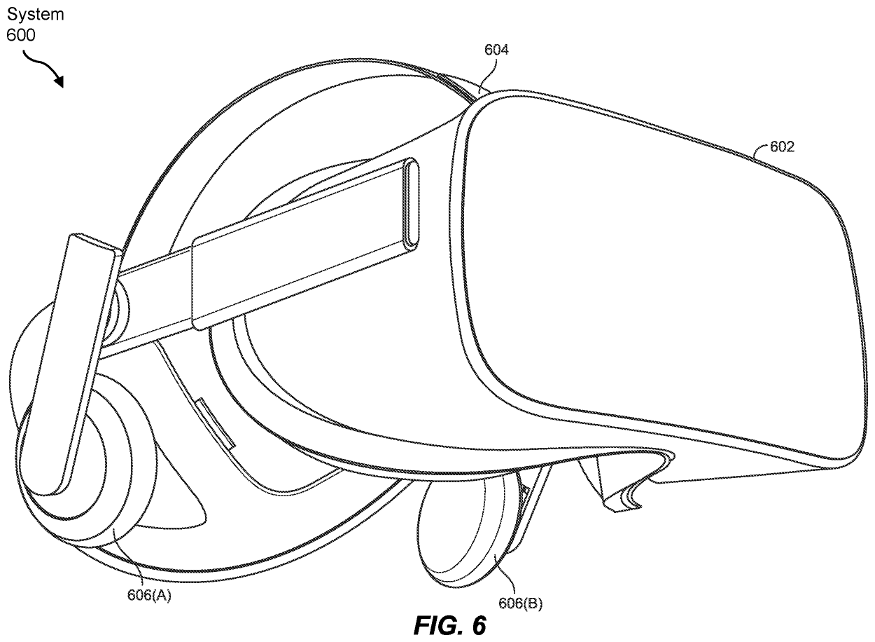

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 500 in FIG. 5) or that visually immerses a user in an artificial reality (such as, e.g., virtual-reality system 600 in FIG. 6). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 5, augmented-reality system 500 may include an eyewear device 502 with a frame 510 configured to hold a left display device 515(A) and a right display device 515(B) in front of a user's eyes. Display devices 515(A) and 515(B) may act together or independently to present an image or series of images to a user. While augmented-reality system 500 includes two displays, embodiments of this disclosure may be implemented in augmented-reality systems with a single NED or more than two NEDs.

In some embodiments, augmented-reality system 500 may include one or more sensors, such as sensor 540. Sensor 540 may generate measurement signals in response to motion of augmented-reality system 500 and may be located on substantially any portion of frame 510. Sensor 540 may represent one or more of a variety of different sensing mechanisms, such as a position sensor, an inertial measurement unit (IMU), a depth camera assembly, a structured light emitter and/or detector, or any combination thereof. In some embodiments, augmented-reality system 500 may or may not include sensor 540 or may include more than one sensor. In embodiments in which sensor 540 includes an IMU, the IMU may generate calibration data based on measurement signals from sensor 540. Examples of sensor 540 may include, without limitation, accelerometers, gyroscopes, magnetometers, other suitable types of sensors that detect motion, sensors used for error correction of the IMU, or some combination thereof.

In some examples, augmented-reality system 500 may also include a microphone array with a plurality of acoustic transducers 520(A)-520(J), referred to collectively as acoustic transducers 520. Acoustic transducers 520 may represent transducers that detect air pressure variations induced by sound waves. Each acoustic transducer 520 may be configured to detect sound and convert the detected sound into an electronic format (e.g., an analog or digital format). The microphone array in FIG. 5 may include, for example, ten acoustic transducers: 520(A) and 520(B), which may be designed to be placed inside a corresponding ear of the user, acoustic transducers 520(C), 520(D), 520(E), 520(F), 520(G), and 520(H), which may be positioned at various locations on frame 510, and/or acoustic transducers 520(I) and 520(J), which may be positioned on a corresponding neckband 505.

In some embodiments, one or more of acoustic transducers 520(A)-(J) may be used as output transducers (e.g., speakers). For example, acoustic transducers 520(A) and/or 520(B) may be earbuds or any other suitable type of headphone or speaker.

The configuration of acoustic transducers 520 of the microphone array may vary. While augmented-reality system 500 is shown in FIG. 5 as having ten acoustic transducers 520, the number of acoustic transducers 520 may be greater or less than ten. In some embodiments, using higher numbers of acoustic transducers 520 may increase the amount of audio information collected and/or the sensitivity and accuracy of the audio information. In contrast, using a lower number of acoustic transducers 520 may decrease the computing power required by an associated controller 550 to process the collected audio information. In addition, the position of each acoustic transducer 520 of the microphone array may vary. For example, the position of an acoustic transducer 520 may include a defined position on the user, a defined coordinate on frame 510, an orientation associated with each acoustic transducer 520, or some combination thereof.

Acoustic transducers 520(A) and 520(B) may be positioned on different parts of the user's ear, such as behind the pinna, behind the tragus, and/or within the auricle or fossa. Or, there may be additional acoustic transducers 520 on or surrounding the ear in addition to acoustic transducers 520 inside the ear canal. Having an acoustic transducer 520 positioned next to an ear canal of a user may enable the microphone array to collect information on how sounds arrive at the ear canal. By positioning at least two of acoustic transducers 520 on either side of a user's head (e.g., as binaural microphones), augmented-reality system 500 may simulate binaural hearing and capture a 3D stereo sound field around about a user's head. In some embodiments, acoustic transducers 520(A) and 520(B) may be connected to augmented-reality system 500 via a wired connection 530, and in other embodiments acoustic transducers 520(A) and 520(B) may be connected to augmented-reality system 500 via a wireless connection (e.g., a BLUETOOTH connection). In still other embodiments, acoustic transducers 520(A) and 520(B) may not be used at all in conjunction with augmented-reality system 500.

Acoustic transducers 520 on frame 510 may be positioned in a variety of different ways, including along the length of the temples, across the bridge, above or below display devices 515(A) and 515(B), or some combination thereof. Acoustic transducers 520 may also be oriented such that the microphone array is able to detect sounds in a wide range of directions surrounding the user wearing the augmented-reality system 500. In some embodiments, an optimization process may be performed during manufacturing of augmented-reality system 500 to determine relative positioning of each acoustic transducer 520 in the microphone array.

In some examples, augmented-reality system 500 may include or be connected to an external device (e.g., a paired device), such as neckband 505. Neckband 505 generally represents any type or form of paired device. Thus, the following discussion of neckband 505 may also apply to various other paired devices, such as charging cases, smart watches, smart phones, wrist bands, other wearable devices, hand-held controllers, tablet computers, laptop computers, other external compute devices, etc.

As shown, neckband 505 may be coupled to eyewear device 502 via one or more connectors. The connectors may be wired or wireless and may include electrical and/or non-electrical (e.g., structural) components. In some cases, eyewear device 502 and neckband 505 may operate independently without any wired or wireless connection between them. While FIG. 5 illustrates the components of eyewear device 502 and neckband 505 in example locations on eyewear device 502 and neckband 505, the components may be located elsewhere and/or distributed differently on eyewear device 502 and/or neckband 505. In some embodiments, the components of eyewear device 502 and neckband 505 may be located on one or more additional peripheral devices paired with eyewear device 502, neckband 505, or some combination thereof.

Pairing external devices, such as neckband 505, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 500 may be provided by a paired device or shared between a paired device and an eyewear device, thus reducing the weight, heat profile, and form factor of the eyewear device overall while still retaining desired functionality. For example, neckband 505 may allow components that would otherwise be included on an eyewear device to be included in neckband 505 since users may tolerate a heavier weight load on their shoulders than they would tolerate on their heads. Neckband 505 may also have a larger surface area over which to diffuse and disperse heat to the ambient environment. Thus, neckband 505 may allow for greater battery and computation capacity than might otherwise have been possible on a standalone eyewear device. Since weight carried in neckband 505 may be less invasive to a user than weight carried in eyewear device 502, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 505 may be communicatively coupled with eyewear device 502 and/or to other devices. These other devices may provide certain functions (e.g., tracking, localizing, depth mapping, processing, storage, etc.) to augmented-reality system 500. In the embodiment of FIG. 5, neckband 505 may include two acoustic transducers (e.g., 520(l) and 520(J)) that are part of the microphone array (or potentially form their own microphone subarray). Neckband 505 may also include a controller 525 and a power source 535.

Acoustic transducers 520(1) and 520(J) of neckband 505 may be configured to detect sound and convert the detected sound into an electronic format (analog or digital). In the embodiment of FIG. 5, acoustic transducers 520(I) and 520(J) may be positioned on neckband 505, thereby increasing the distance between the neckband acoustic transducers 520(I) and 520(J) and other acoustic transducers 520 positioned on eyewear device 502. In some cases, increasing the distance between acoustic transducers 520 of the microphone array may improve the accuracy of beamforming performed via the microphone array. For example, if a sound is detected by acoustic transducers 520(C) and 520(D) and the distance between acoustic transducers 520(C) and 520(D) is greater than, e.g., the distance between acoustic transducers 520(D) and 520(E), the determined source location of the detected sound may be more accurate than if the sound had been detected by acoustic transducers 520(D) and 520(E).

Controller 525 of neckband 505 may process information generated by the sensors on neckband 505 and/or augmented-reality system 500. For example, controller 525 may process information from the microphone array that describes sounds detected by the microphone array. For each detected sound, controller 525 may perform a direction-of-arrival (DOA) estimation to estimate a direction from which the detected sound arrived at the microphone array. As the microphone array detects sounds, controller 525 may populate an audio data set with the information. In embodiments in which augmented-reality system 500 includes an inertial measurement unit, controller 525 may compute all inertial and spatial calculations from the IMU located on eyewear device 502. A connector may convey information between augmented-reality system 500 and neckband 505 and between augmented-reality system 500 and controller 525. The information may be in the form of optical data, electrical data, wireless data, or any other transmittable data form. Moving the processing of information generated by augmented-reality system 500 to neckband 505 may reduce weight and heat in eyewear device 502, making it more comfortable to the user.

Power source 535 in neckband 505 may provide power to eyewear device 502 and/or to neckband 505. Power source 535 may include, without limitation, lithium-ion batteries, lithium-polymer batteries, primary lithium batteries, alkaline batteries, or any other form of power storage. In some cases, power source 535 may be a wired power source. Including power source 535 on neckband 505 instead of on eyewear device 502 may help better distribute the weight and heat generated by power source 535.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 600 in FIG. 6, that mostly or completely covers a user's field of view. Virtual-reality system 600 may include a front rigid body 602 and a band 604 shaped to fit around a user's head. Virtual-reality system 600 may also include output audio transducers 606(A) and 606(B). Furthermore, while not shown in FIG. 6, front rigid body 602 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 500 and/or virtual-reality system 600 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 500 and/or virtual-reality system 600 may include microLED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 500 and/or virtual-reality system 600 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As mentioned above, one or more of the systems described herein may include a smartwatch, which may include a wearable computer in the form of a wristwatch. FIG. 7 shows a view 700 of an example smartwatch 702. As shown, example smartwatch 702 may include or implement a variety of components that may serve or support various computing functions such as a battery 704, a central processing unit 706 (“CPU 706” in FIG. 7) a speaker 708, and a display 710. Additionally, example smartwatch 702 may include various components that may be used as a sensor (e.g., a sensor 152) such as a microphone 712 and a thermometer 714. Although not shown in FIG. 7, example smartwatch 702 may include any other suitable sensors such as those described herein (e.g., cameras, proximity sensors, motion sensors, etc.).

As further shown in FIG. 7, example smartwatch 702 may also include an antenna 716 that may be used as one of a plurality of antennas (e.g., antennas 154). Although only shown as a single antenna in FIG. 7, antenna 716 may include or represent a plurality of antennas that may be configured to transmit and/or receive a variety of electromagnetic signals and/or configured to implement a plurality of wireless standards.

The following example embodiments are also included in this disclosure:

Example 1: A computer-implemented method comprising (1) receiving, via a sensor included in an artificial reality system, data representative of an environment local to the artificial reality system, (2) determining, based on the received data representative of the environment, a probability that an environmental condition will impact a use of a plurality of antennas included in the artificial reality system by the artificial reality system, and (3) adjusting, in response to the determined probability that environmental condition will impact the use of the plurality of antennas, the use of the plurality of antennas by the artificial reality system.

Example 2: The computer-implemented method of example 1, further comprising determining, based on the data representative of the environment local to the artificial reality system, the environmental condition.

Example 3: The computer-implemented method of any of examples 1-2, wherein the environmental condition comprises a proximity of an external object to at least one antenna included in the plurality of antennas.

Example 4: The computer-implemented method of example 3, wherein the external object comprises a body part of a user.

Example 5: The computer-implemented method of any of examples 1-4, wherein the environmental condition comprises a temperature differential between a first antenna included in the plurality of antennas and a second antenna included in the plurality of antennas.

Example 6: The computer-implemented method of any of examples 1-5, wherein the sensor comprises at least one of (1) a camera, (2) an array of cameras, (3) a computer vision system, (4) a simultaneous localization and mapping (SLAM) subsystem, (5) a temperature sensor, (6) a touch sensor, (7) an orientation sensor, (8) a proximity sensor, or (9) a motion sensor.

Example 7: The computer-implemented method of any of examples 1-6, wherein the plurality of antennas included in the artificial reality system comprises at least a first antenna and a second antenna.

Example 8: The computer-implemented method of example 7, wherein adjusting the use of the plurality of antennas comprises adjusting a transmit path of the artificial reality system such that the transmit path excludes the first antenna and includes the second antenna.

Example 9: The computer-implemented method of any of examples 7-8, wherein adjusting the use of the plurality of antennas comprises at least one of (1) decreasing an input sensitivity of the first antenna and increasing an input sensitivity of the second antenna, or (2) decreasing a power output of the first antenna and increasing a power output of the second antenna.

Example 10: The computer-implemented method of any of examples 7-9, wherein adjusting the use of the plurality of antennas comprises (1) transitioning the first antenna from an active state to an inactive state, and (2) transitioning the second antenna from an inactive state to an active state.

Example 11: The computer-implemented method of any of examples 1-10, wherein the use of the plurality of antennas included in the artificial reality system comprises at least one of (1) receiving of an input signal, or (2) transmitting of an output signal.

Example 12: The computer-implemented method of example 11, wherein (1) the use of the plurality of the antennas included in the artificial reality system is in accordance with at least one wireless communication standard, and (2) the wireless communication standard comprises at least one of (A) a personal-area networking (PAN) wireless standard, (B) a local-area networking (LAN) wireless standard, or (C) a wide-area networking (WAN) wireless standard.

Example 13: The computer-implemented method of example 12, wherein (1) the wireless communication standard comprises the PAN wireless standard, and (2) the PAN wireless standard comprises at least one of (A) a Bluetooth wireless standard, (B) a Wi-Fi Direct wireless standard, or (C) a near-field communication (NFC) wireless standard.

Example 14: The computer-implemented method of any of examples 12-13, wherein (1) the wireless communication standard comprises the LAN wireless standard, and (2) the LAN wireless standard comprises a Wi-Fi wireless standard.

Example 15: The computer-implemented method of any of examples 12-14, wherein (1) the wireless communication standard comprises the WAN wireless standard, and (2) the WAN wireless standard comprises at least one of (A) Code Division Multiple Access (CDMA) wireless standard (B) a Global System for Mobile (GSM) wireless standard, (C) a General Packet Radio Service (GPRS) wireless standard, (D) a Long-Term Evolution (LTE) wireless standard, or (E) a Fifth Generation (5G) wireless standard.

Example 16: A system comprising (1) an artificial reality system comprising (A) at least one sensor, and (B) a plurality of antennas, (2) a receiving module, stored in memory, that receives, via the sensor, data representative of an environment local to the artificial reality system, (3) a determining module, stored in memory, that determines, based on the received data representative of the environment, a probability that an environmental condition will impact a use, by the artificial reality system, of the plurality of antennas, (4) an adjusting module, stored in memory, that adjusts, in response to the determined probability that the environmental condition will impact the use of the plurality of antennas, the use, by the artificial reality system, of the plurality of antennas by the artificial reality system, and (5) at least one physical processor that executes the receiving module, the determining module, and the adjusting module.

Example 17: The system of example 16, wherein the environmental condition comprises at least one of (1) a proximity of an external object to at least one antenna included in the plurality of antennas, (2) a proximity of a body part of a user of the artificial reality system to at least one antenna included in the plurality of antennas, and (3) a temperature differential between a first antenna included in the plurality of antennas and a second antenna included in the plurality of antennas.

Example 18: The system of any of examples 16-17, wherein (1) the plurality of antennas comprises at least a first antenna and a second antenna, and (2) the adjusting module adjusts the use of the plurality of antennas by at least one of (A) decreasing an input sensitivity of the first antenna and increasing an input sensitivity of the second antenna, or (B) decreasing a power output of the first antenna and increasing a power output of the second antenna.

Example 19: A non-transitory computer-readable medium comprising computer-readable instructions that, when executed by at least one processor of a computing system, cause the computing system to (1) receive, from a sensor included in an artificial reality system, data representative of an environment local to the artificial reality system, (2) determine, based on the received data representative of the environment, a probability that an environmental condition will impact a use of a plurality of antennas included in the artificial reality system by the artificial reality system, and (3) adjust, in response to the determined probability that environmental condition the environment will interfere with the use of the plurality of antennas, the use of the plurality of antennas by the artificial reality system.

Example 20: The non-transitory computer-readable medium of example 19, wherein (1) the plurality of antennas comprises at least a first antenna and a second antenna, and (2) when executed by the at least one processor of the computing system, the computer-readable instructions further cause the computing system to adjust the use of the plurality of antennas by at least one of (A) decreasing an input sensitivity of the first antenna and increasing an input sensitivity of the second antenna, or (B) decreasing a power output of the first antenna and increasing a power output of the second antenna.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive sensor data to be transformed, transform the sensor data, output a result of the transformation to determine a probability that an environmental condition will impact a use of a plurality of antennas included in an artificial reality system, use the result of the transformation to adjust the use of the plurality of antennas, and store the result of the transformation to perform future probability determinations. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, via a sensor included in an artificial reality system, data representative of an environment local to the artificial reality system;
determining, based on the received data representative of the environment, a probability that an environmental condition will impact a use of a plurality of antennas included in the artificial reality system by the artificial reality system; and
adjusting, in response to the determined probability that environmental condition will impact the use of the plurality of antennas, the use of the plurality of antennas by the artificial reality system.

2. The computer-implemented method of claim 1, further comprising determining, based on the data representative of the environment local to the artificial reality system, the environmental condition.

3. The computer-implemented method of claim 1, wherein the environmental condition comprises a proximity of an external object to at least one antenna included in the plurality of antennas.

4. The computer-implemented method of claim 3, wherein the external object comprises a body part of a user.

5. The computer-implemented method of claim 1, wherein the environmental condition comprises a temperature differential between a first antenna included in the plurality of antennas and a second antenna included in the plurality of antennas.

6. The computer-implemented method of claim 1, wherein the sensor comprises at least one of:
a camera;
an array of cameras;
a computer vision system;
a simultaneous localization and mapping (SLAM) subsystem;
a temperature sensor;
a touch sensor;
an orientation sensor;
a proximity sensor; or
a motion sensor.

7. The computer-implemented method of claim 1, wherein the plurality of antennas included in the artificial reality system comprises at least a first antenna and a second antenna.

8. The computer-implemented method of claim 7, wherein adjusting the use of the plurality of antennas comprises adjusting a transmit path of the artificial reality system such that the transmit path excludes the first antenna and includes the second antenna.

9. The computer-implemented method of claim 7, wherein adjusting the use of the plurality of antennas comprises at least one of:
decreasing an input sensitivity of the first antenna and increasing an input sensitivity of the second antenna; or
decreasing a power output of the first antenna and increasing a power output of the second antenna.

10. The computer-implemented method of claim 7, wherein adjusting the use of the plurality of antennas comprises:
transitioning the first antenna from an active state to an inactive state; and
transitioning the second antenna from an inactive state to an active state.

11. The computer-implemented method of claim 1, wherein the use of the plurality of antennas included in the artificial reality system comprises at least one of:
receiving of an input signal; or
transmitting of an output signal.

12. The computer-implemented method of claim 11, wherein:
the use of the plurality of the antennas included in the artificial reality system is in accordance with at least one wireless communication standard; and
the wireless communication standard comprises at least one of:
a personal-area networking (PAN) wireless standard;
a local-area networking (LAN) wireless standard; or
a wide-area networking (WAN) wireless standard.

13. The computer-implemented method of claim 12, wherein:
the wireless communication standard comprises the PAN wireless standard; and
the PAN wireless standard comprises at least one of:
a Bluetooth wireless standard;
a Wi-Fi Direct wireless standard; or
a near-field communication (NFC) wireless standard.

14. The computer-implemented method of claim 12, wherein:
the wireless communication standard comprises the LAN wireless standard; and
the LAN wireless standard comprises a Wi-Fi wireless standard.

15. The computer-implemented method of claim 12, wherein:
the wireless communication standard comprises the WAN wireless standard; and
the WAN wireless standard comprises at least one of:
Code Division Multiple Access (CDMA) wireless standard;
a Global System for Mobile (GSM) wireless standard;
a General Packet Radio Service (GPRS) wireless standard;
a Long-Term Evolution (LTE) wireless standard; or
a Fifth Generation (5G) wireless standard.

16. A system comprising:
an artificial reality system comprising:
at least one sensor; and
a plurality of antennas;
a receiving module, stored in memory, that receives, via the sensor, data representative of an environment local to the artificial reality system;
a determining module, stored in memory, that determines, based on the received data representative of the environment, a probability that an environmental condition will impact a use, by the artificial reality system, of the plurality of antennas;
an adjusting module, stored in memory, that adjusts, in response to the determined probability that the environmental condition will impact the use of the plurality of antennas, the use, by the artificial reality system, of the plurality of antennas by the artificial reality system; and
at least one physical processor that executes the receiving module, the determining module, and the adjusting module.

17. The system of claim 16, wherein the environmental condition comprises at least one of:
a proximity of an external object to at least one antenna included in the plurality of antennas;
a proximity of a body part of a user of the artificial reality system to at least one antenna included in the plurality of antennas; and
a temperature differential between a first antenna included in the plurality of antennas and a second antenna included in the plurality of antennas.

18. The system of claim 16, wherein:
the plurality of antennas comprises at least a first antenna and a second antenna; and
the adjusting module adjusts the use of the plurality of antennas by at least one of:
decreasing an input sensitivity of the first antenna and increasing an input sensitivity of the second antenna; or
decreasing a power output of the first antenna and increasing a power output of the second antenna.

19. A non-transitory computer-readable medium comprising computer-readable instructions that, when executed by at least one processor of a computing system, cause the computing system to:
receive, from a sensor included in an artificial reality system, data representative of an environment local to the artificial reality system;
determine, based on the received data representative of the environment, a probability that an environmental condition will impact a use of a plurality of antennas included in the artificial reality system by the artificial reality system; and
adjust, in response to the determined probability that environmental condition the environment will interfere with the use of the plurality of antennas, the use of the plurality of antennas by the artificial reality system.

20. The non-transitory computer-readable medium of claim 19, wherein:
the plurality of antennas comprises at least a first antenna and a second antenna; and
when executed by the at least one processor of the computing system, the computer-readable instructions further cause the computing system to adjust the use of the plurality of antennas by at least one of:
decreasing an input sensitivity of the first antenna and increasing an input sensitivity of the second antenna; or
decreasing a power output of the first antenna and increasing a power output of the second antenna.
